(19) United States
(12) Patent Application Publication
(10) Pub. No.: US 2025/0141541 A1
(43) Pub. Date: May 1, 2025

(54) ORBITAL RESILIENT BLOCKCHAIN-ENABLED INTER-AGENT TRANSACTION SERVICE PROTOCOL

(71) Applicant: THE JOHNS HOPKINS UNIVERSITY, Baltimore, MD (US)

(72) Inventors: Gregory FALCO, Baltimore, MD (US); Nathaniel GORDON, Baltimore, MD (US)

(21) Appl. No.: 18/834,007

(22) PCT Filed: Jan. 31, 2023
(86) PCT No.: PCT/US2023/011965

§ 371 Date: Jul. 29, 2024

Related U.S. Application Data
(60) Provisional application No. 63/306,192, filed on Feb. 3, 2022.

(51) Int. Cl. H04B 7/185

(52) U.S. Cl. CPC H04B 7/18565

(57) ABSTRACT

Techniques for communicating between a first satellite payload in an electronic distributed ledger network and a second satellite payload in the electronic distributed ledger network are presented. The techniques include: providing, by the first satellite payload and to the distributed ledger network, a request for a service; obtaining, by the first satellite payload, a service response from the second satellite payload and an indication of compliance with a policy concerning the service; determining, by the first satellite payload, and based on the indication of compliance, whether the service response conforms to the policy concerning the service; and acting on the service response, by the first satellite payload, based on the determining.

### CROSS-REFERENCE TO RELATED APPLICATIONS

This application is the national stage entry of International Patent Application No. PCT/US2023/011965, filed on Jan. 31, 2023, and published as WO 2023/150103 A1 on Aug. 10, 2023, which claims the benefit of U.S. Provisional Patent Application No. 63/306, 192, filed on Feb. 3, 2022, which are hereby incorporated by reference herein in their entireties.

### FIELD

This disclosure relates generally to communications between spacecraft, such as satellites.

### BACKGROUND

To provide shared services across a single bus, satellite payloads must communicate with each other, but there is currently no way to achieve this without integrity concerns unless interacting payloads are all developed or operated by the same entity. Should two satellite payloads wish to share services, such as use of a graphics processing unit (GPU), there are no means for mediated interaction. There is either open communication over the bus or no engagement at all.

To truly scale operating capacity, the space sector may evolve from the traditional, vertically integrated space vehicle development and operations model to facilitate the exchange of services across multiple payloads owned and operated by different parties. While there is commercial and government interest in providing infrastructure as a service capabilities, there are functional challenges—the principal being a matter of security.

When available, security for inter-agent interactions may be centralized, where there is a single application that has supervisory control over the exchange. For example, to provide services between two payloads (either on the same bus or across vehicles) that do not inherently trust each other, a moderator may be used to ensure a fair interaction. However, a centralized moderation capability presents a ripe target for an attacker, eliminating any semblance of a zero-trust exchange. For example, centralized security is imperfect because a malicious actor could corrupt the central supervisor, rendering the exchange compromised.

Other security approaches within the same bus include hosting payloads in different virtual machines (VMs), thereby isolating each payload, providing some security and enhancing resident software isolation from other environments. Hypervisors may afford the central management of multiple VMs, but again, this could become compromised which limits the extent of security provided by the VMs. Commanding multiple payloads in a given hypervisor across vendors would require prior planning and trust vetting by the payload developers and cannot be configured on-the-fly when service across payloads is needed. While hypervisors can help to manage VMs, they do not facilitate a trustless exchange of information between them, nor can they enforce policies governing integral interactions across the VMs.

There is currently interest in engaging across payloads using homomorphic encryption; however, this is a slow and compute-intensive process that is not viable on a space vehicle today.

In sum, today, there are no secure means for satellites across constellations to share services without a trusted transaction.

### SUMMARY

According to various embodiments, a non-transitory computer readable medium comprising instructions that, when executed by an electronic processor, configures the electronic processor to perform a method of communicating between a first satellite payload in an electronic distributed ledger network and a second satellite payload in the electronic distributed ledger network is presented. The actions include: providing, by the first satellite payload and to the distributed ledger network, a request for a service; obtaining, by the first satellite payload, a service response from the second satellite payload and an indication of compliance with a policy concerning the service; determining, by the first satellite payload, and based on the indication of compliance, whether the service response conforms to the policy concerning the service; and acting on the service response, by the first satellite payload, based on the determining.

Various optional features of the above embodiments include the following. The determining may include determining that the service response conforms to the policy concerning the service, and the acting on the service may include processing the service response by the first satellite payload. The determining may include determining that the service response does not conform to the policy concerning the service, and the acting on the service may include sending, by the first satellite payload and to at least one node in the electronic distributed ledger network, a request to validate non-conformance of the service response to the policy concerning the service. The actions may further include: receiving, by the first satellite payload and from at least one node in the electronic distributed ledger network, a consensus indication of non-conformance of the service response to the policy concerning the service, and refusing entry of the service response to the first satellite payload. The electronic distributed ledger network may include one of a blockchain network or a directed acyclic graph network. The receiving may include retrieving the indication of compliance with the policy concerning the service from the electronic distributed ledger network. The first satellite payload and the second satellite payload may be hosted payloads present on a same satellite, and the sending may be performed over an electronic bus. The first satellite payload may be present on a first satellite and the second satellite payload may be present on a second satellite different from the first satellite, and the sending may be performed over a wireless communication channel. The service may include at least one of: computation time, data storage, or sensor data acquisition. The actions may further include: obtaining, by the first satellite payload and from the electronic distributed ledger network, an indication of past compliance by the second satellite payload. The actions may further include: advertising in a data and services marketplace, by the first satellite payload, a service that it is capable of providing and that is available for request.

According to various embodiments, a method of communicating between a first satellite payload in an electronic distributed ledger network and a second satellite payload in the electronic distributed ledger network is presented. The method includes: providing, by the first satellite payload and to the distributed ledger network, a request for a service; obtaining, by the first satellite payload, a service response from the second satellite payload and an indication of compliance with a policy concerning the service; determining, by the first satellite payload, and based on the indication of compliance, whether the service response conforms to the policy concerning the service; and acting on the service response, by the first satellite payload, based on the determining.

Various optional features of the above embodiments include the following. The determining may include determining that the service response conforms to the policy concerning the service, and the acting on the service may include processing the service response by the first satellite payload. The determining may include determining that the service response does not conform to the policy concerning the service, and the acting on the service may include sending, by the first satellite payload and to at least one node in the electronic distributed ledger network, a request to validate non-conformance of the service response to the policy concerning the service. The method may further include: receiving, by the first satellite payload and from at least one node in the electronic distributed ledger network, a consensus indication of non-conformance of the service response to the policy concerning the service, and refusing entry of the service response to the first satellite payload. The electronic distributed ledger network may include one of a blockchain network or a directed acyclic graph network. The receiving may include retrieving the indication of compliance with the policy concerning the service from the electronic distributed ledger network. The first satellite payload and the second satellite payload may be hosted payloads present on a same satellite, and the sending may be performed over an electronic bus. The first satellite payload may be present on a first satellite and the second satellite payload is present on a second satellite different from the first satellite, and the sending may be performed over a wireless communication channel. The service may include at least one of: computation time, data storage, or sensor data acquisition. The method may further include: obtaining, by the first satellite payload and from the electronic distributed ledger network, an indication of past compliance by the second satellite payload. The method may further include: advertising in a data and services marketplace, by the first satellite payload, a service that it is capable of providing and that is available for request.

Combinations, (including multiple dependent combinations) of the above-described elements and those within the specification have been contemplated by the inventors and may be made, except where otherwise indicated or where contradictory.

### BRIEF DESCRIPTION OF THE DRAWINGS

Various features of the examples can be more fully appreciated, as the same become better understood with reference to the following detailed description of the examples when considered in connection with the accompanying figures, in which:

FIG. 1 is a schematic diagram illustrating satellite constellations;

FIG. 2 is a schematic diagram illustrating interaction principles according to various embodiments;

FIG. 3 is a schematic diagram illustrating an architecture according to various embodiments; and

FIG. 4 is a flowchart illustrating a method of communicating between a first satellite payload in an electronic distributed ledger network and a second satellite payload in the electronic distributed ledger network according to various embodiments.

### DESCRIPTION OF THE EXAMPLES

Reference will now be made in detail to example implementations, illustrated in the accompanying drawings. Wherever convenient, the same reference numbers will be used throughout the drawings to refer to the same or like parts. In the following description, reference is made to the accompanying drawings that form a part thereof, and in which is shown by way of illustration specific exemplary examples in which the invention may be practiced. These examples are described in sufficient detail to enable those skilled in the art to practice the invention, and it is to be understood that other examples may be utilized and that changes may be made without departing from the scope of the invention. The following description is, therefore, merely exemplary.

Exponential growth of the space industry avails unprecedented opportunities to establish a marketplace of satellite infrastructure services. However, security and resource constraints pose critical challenges to implementing the exchange of services such as storage, computation, or even arm-based manipulation.

Some embodiments provide a fully distributed architecture that facilitates resilient, trustless interactions to furnish space infrastructure as a service (SIAAS). According to some embodiments, the distributed architecture engages Distributed Ledger Technology (DLT), such as a blockchain or directed acyclic graph, to designate and enforce security policy between multiple parties across payloads owned or operated by different service providers on the same satellite bus, across a constellation, or between constellations. Some embodiments provide a zero-trust SIAAS architecture. According to some embodiments, the architecture addresses critical challenges such as consensus and cyber resilience to facilitate a space services marketplace.

The distributed architecture according to some embodiments may use a blockchain or other DLT to designate and enforce security policy between multiple parties across payloads owned or operated by different service providers on the same bus or across a constellation. The DLT-enabled architecture provides a consensus mechanism to identify bad actors across the architecture and is resilient to node failures or attacks. Policy defining interactions that are delivered over the DLT provides the benefits of a software-defined network, with the resilience afforded by a DLT.

Establishing a trustless and resilient mechanism for payloads owned by different organizations to engage with each other, as provided by some embodiments, could be transformative for the sector. Rather than building out vertically integrated space assets, startups can focus on niche capabilities while relying on payloads, developed by other organizations, for supporting services, thereby reducing the barrier to entry to the space sector. Commercial organizations can offer revenue-generating services to others requiring infrastructure such as computation, storage, and sensors, without the concern of being harmed in the process. Drastic cost reductions are possible for developers and space operators if they can securely rely on others for service. Similarly, defense and intelligence agencies can reduce their operating costs and increase their launch and operating capacity by relying on the private sector to provide support services. Ultimately, similar to how cloud services reduced the barrier to entry for organizations wishing to engage with resource-intensive procedures, trustless, resilient, facilitated mechanisms to enable SIAAS may similarly benefit the space industry.

In sum, some embodiments provide a resilient architecture and supporting protocol for enabling DLT-backed, integral service sharing between critical space assets.

These and other features and advantages are presented in detail herein in reference to the figures.

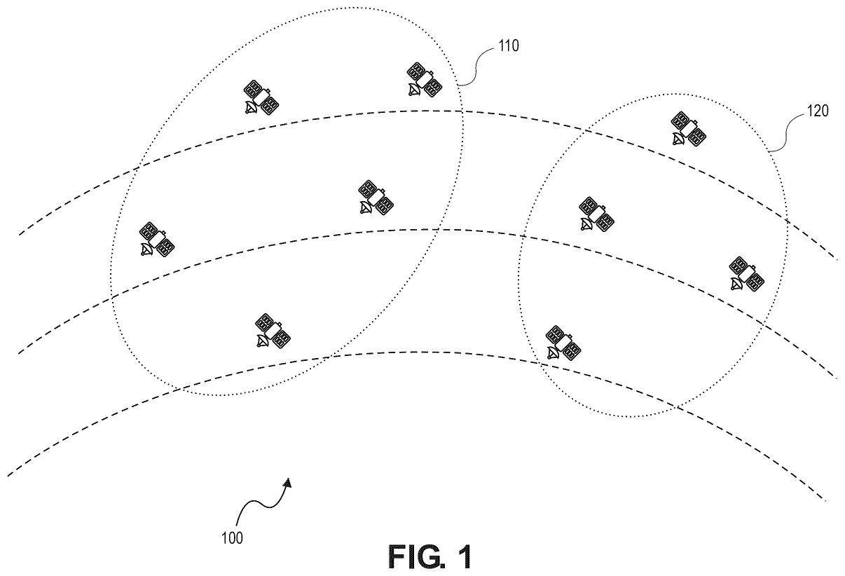

FIG. 1 is a schematic diagram 100 illustrating satellite constellations 110, 120. Satellites within a constellation, e.g., within constellation 110 or within constellation 120, may intercommunicate and operate together as a system. Each constellation 110, 120 includes multiple satellites, which may be in the same or different orbital levels, e.g., Medium Earth orbit (MEO) and/or Low Earth orbit (LEO). The satellites within a constellation may or may not be owned and/or operated by the same entity.

Before space systems are able to exchange services, reliable and secure links between assets may be established. While space links have existed for decades, researchers, government organizations and industry are still developing and refining media for space-related communications. Today, communications from space vehicles to other assets—be they ground stations or other space vehicles—are designed to be received by trusted agents, usually over an encrypted link. However, the assumption that data sharing is only necessary among trusted parties is flawed. Future space vehicles will be highly interdependent and may require transacting data and services with others to enable seamless operations. As shown in FIG. 1, constellations 110 and 120 include cross-link capability within the respective constellation.

Communicating with space vehicles may utilize a series of high-powered antennas and radio transceivers that align at the right time for radio frequency (RF) exchange. There are frequent interference events for any given RF spectrum, which results in lost signal. Some of this interference is intentional (jamming, spoofing or replay attacks) while other times it is accidental or atmospheric. Interruption or loss of signal could be detrimental to satellite service integrity.

While RF can also be used between space vehicles, optical signal offers an alternative means of communication. Optical communications offer a number of benefits compared with RF including high data rates, precision pointing, license-free spectrum and large bandwidth.

Integrating the two communication modalities, RF and optical, across a multi-agent space network could help to leverage the strengths of each, while mitigating their challenges. Space-Based Adaptive Communications Node (Space-BACN) is a DARPA program that aims to establish a space internet across distributed networking assets and constituent participating nodes. Space-BACN can transform the sector by enabling a communication ecosystem with heterogeneous assets; however facilitating zero-trust exchange of services will persist as a gap that could inhibit the desire for space systems to interact.

Various embodiments may utilize RF, optical, or hybrid (e.g., Space-BACN) communications channels for messages between satellite payloads that are present on different satellites. Various embodiments may utilize a bus for messages between satellite payloads that are present on the same satellite.

Various embodiments may utilize Distributed Ledger Technology (DLT), non-limiting examples of which are described presently. In general, DLT may help exchange information and services in a resilient way between space vehicles (and/or payloads) and their interdependent assets.

DLT may include a distributed, shared and synchronized database, a ledger, that exists across multiple locations. Participants in a DLT may be referred to as “nodes,” and may each store a copy of the ledger. In general, changes published to a ledger of one node may be propagated to all of the ledgers in other nodes in a DLT using known DLT consensus techniques. There are both permissioned and permissionless ledgers. Permissioned ledgers are distributed and synchronized, but access to the system is controlled by a single administrator. This generally means that permissioned DLTs are smaller and inherently more private given there are access controls. Permissionless DLTs are open to the public where anyone with a server and the appropriate software can participate.

The most popular DLT is a blockchain, which was introduced in 2008 by Satoshi Nakamoto in a white paper detailing the operations of Bitcoin, a peer-to-peer currency exchange system. A blockchain captures incremental data transactions in “blocks” that are confirmed by nodes called miners. Consensus across the miners is used before data can be hashed on to the blocks which are connected in a chronological chain after being identified by a cryptographic hash.

Blockchains are considered to be resilient to attack and of high integrity as the compromise of any single node or collection of nodes will not be sufficient to change the history recorded by all the distributed nodes across the chain. 51% of the processing power commanding the miners of a blockchain would need to be compromised to achieve what is called a “double-spend” attack, where recently hashed blocks could theoretically be re-allocated. The size and hash rate of large blockchains such as Bitcoin makes the 51% attack extremely unlikely to occur given the massive amount of computing power that would be required to take over 51% of the mining power of the chain.

Bitcoin is a permissionless blockchain, as is Ethereum (first described in 2013)—a blockchain that allows contracting between parties via “smart contracts.” There are several examples of permissioned blockchains in production, such as Hyperledger, which was started in 2015. Permissioned blockchains may be engaged when there is an agreed-upon central authority, whereas permissionless chains may be used for transactions that seek no authoritative governor of who can partake in the transactions and visibility of the ledger. Blockchains such as Bitcoin and Ethereum require a certain amount of memory for the storage of blocks as well as processing power in order to mine each transaction and hash it onto the chain. This has presented challenges for engaging blockchain on constrained industrial internet of things devices that could otherwise benefit from the integrity features previously described. Several modifications of both the Bitcoin and Ethereum blockchain exist which aim to preserve the benefits of these large chains, while enabling operations on constrained devices.

Another type of DLT is a Directed Acyclic Graph (DAG). They are far less popular than blockchains, but also offer benefits associated with distributed ledgers. Instead of forming blocks where consensus is required across the majority of nodes, transactions are written on the ledger and then may validate two other unvalidated transactions before being posted. The transaction then may be validated by newer succeeding transactions. A benefit of a DAG is that it does not require the extensive processing required to hash transactions to the chain or the memory to replicate the chain on every distributed ledger.

A challenge with DAGs is that some nodes are not traversable from other nodes. This could cause information asymmetry across space vehicles. Such asymmetry can be addressed by establishing a metadata map of the DAGs and their participants that is stored in a distributed way across each participating space vehicle. Distributed Hash Tables (DHTs) can be leveraged for this purpose. Each satellite payload that wises to participate may maintain a DHT of the DAGs so that it can have visibility to the location of desired data or services. The DHT may function as a space vehicle storefront data and service directory.

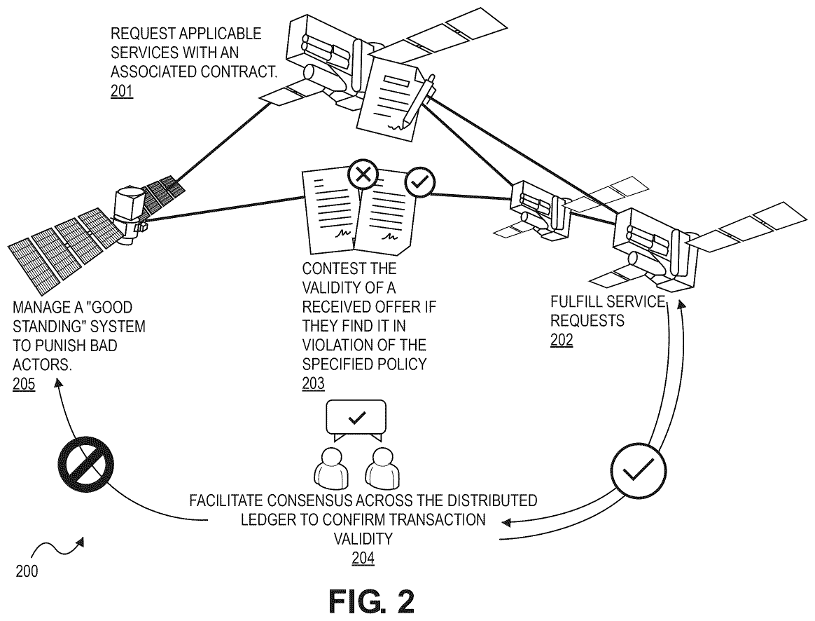

FIG. 2 is a schematic diagram illustrating interaction principles 200 according to various embodiments. Communicating information such as operational state and available services may implicate high reliability, low-latency, and computing resources. The information exchange mechanism may be resilient to a variety of space system attacks. It also may be open so that new systems can engage with the marketplace without previous participation. Given the safety-critical nature of space systems, real-time operations may be feasible and not limited to space vehicles within the same constellation. Due to the exponential growth of space vehicles, the broadcast platform may be fungible and scalable as many more space vehicles may need to be added in the future. Finally, the integration for such systems may be seamless to encourage adoption of the platform. Any asset should be capable of joining, regardless of its resources-assuming connectivity is available.

As shown in FIG. 2, five interaction principles may be achieved for various embodiments to provide a zero-trust services transaction. Satellite payloads may be able to provide any, or any combination, of the following interaction principles: 201, 202, 203, 204, and/or 205:
(201) request applicable services, e.g., with an associated smart contract;
(202) fulfill service requests;
(203) contest the validity of a received offer if they find it in violation of the specified policy;
(204) facilitate a consensus across the DLT to confirm transaction validity; and/or
(205) manage a “good standing” system to punish bad actors.

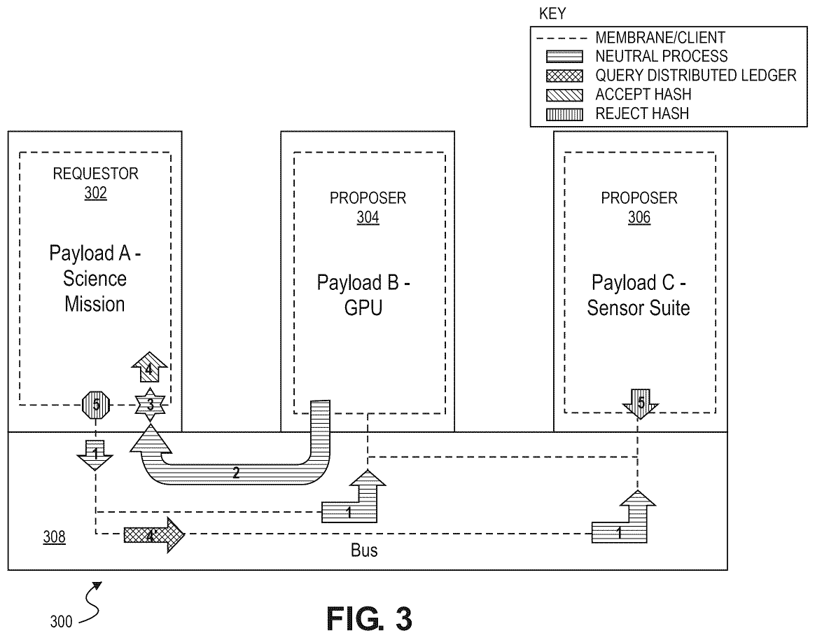

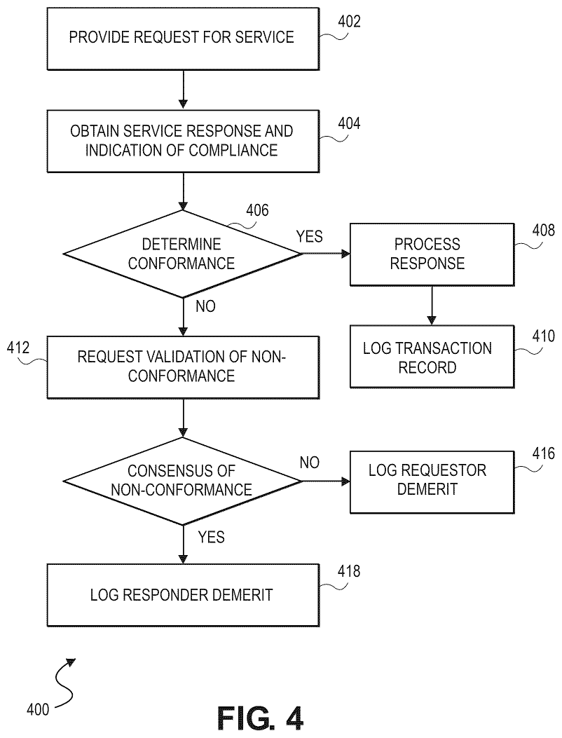

An example architecture that achieves these principles is shown and described herein in reference to FIGS. 3 and 4.

FIG. 3 is a schematic diagram illustrating an architecture 300 according to various embodiments. The architecture 300 may include DLT node client software, e.g., a copy of a distributed ledger. Thus, each satellite payload may include a node of the DLT. The architecture 300 may be implemented in a satellite payload. Although shown in reference to intra-satellite communications among multiple payloads in communication via the satellite's bus, embodiments are not so limited. In general, embodiments may allow for communications and service provision between payloads present in the same of different satellites, and for the latter, between payloads of satellites in the same or in different constellations. By way of non-limiting example, FIG. 3 depicts three payloads: payload A 302, a science mission, payload B 304, a GPU, and payload C 306, a sensor suite. For the architecture 300, any, or any combination, of the following design parameters may be implemented according to various embodiments:
(1) Payloads, such as payload A 302, may be able to request any given service. The requestor should be able to define the specifications for a requested service by stipulating a policy template, or “lock.” Meeting these specifications will predicate accepting a service offered. This may provide features of a software-defined network.
(2) Payloads, such as payload B 304 and payload C 306, may be able to make offers to fulfill service requests. This offer, accompanied by an indication of compliance, or “key,” may be encrypted in such a way as to protect the integrity of the service's contents while remaining transparent enough for an outsider to determine if the key conforms to the defined policy specifications of the policy template (the lock).
(3) Upon receiving a fulfillment offer, a requestor, such as payload A 302, may have the ability to contest the validity of a given offer if they find it to be in violation of the policy, e.g., if the key does not fit the lock.
(4) In the event of a contested transaction, an embodiment may facilitate a consensus across the DLT (e.g., blockchain) to determine whether the requestor or the supplier is at fault, thus presenting the lock and key to be validated by any or all payloads (e.g., 302, 304, 306) across the architecture 300. As shown in FIG. 3, at (4), payload A 302 accepts the offer from payload B 306. As further shown in FIG. 3, at (4′), payload A 302 contests the offer from payload C 306.
(5) Embodiments may be capable of tracking a payload's ‘good’ or ‘bad’ standing to punish bad actors. Punishments must be given to payloads that have a consensus against them (could be the requestor or proposer), or who repeatedly fail to contribute to the consensus of others' transactions.

The architecture 300 may be implemented as hardware, as firmware, or as a software package that allows spacecraft and payload operators to gain access to a wider network of integrally shared services. The network may be built on the back of existing satellite networks. The architecture 300 may be used with any DLT implementation, e.g., a DAG or blockchain. According to various embodiments, each node may store the consensus state of ‘standing’ for each other node in the network to avoid interactions with non-cooperative agents. Additionally, each node's ledger may store a record of service transactions that have occurred on the network. Embodiments may use ledger pruning algorithms to minimize impact on resource-constrained payloads. Light-weight smart contract distributed ledger nodes may be used, by way of non-limiting example.

By way of non-limiting example, and as shown in FIG. 3, multiple payloads, and a bus equipped according to an embodiment, are able to use the spacecraft's data bus to distribute and respond to service queries using a protocol that consistent with the above design parameters and/or the method 400 as shown and described in reference to FIG. 4.

FIG. 4 is a flowchart illustrating a method 400 of communicating between a first satellite payload in an electronic distributed ledger network and a second satellite payload in the electronic distributed ledger network according to various embodiments. In general, the first and second satellite payloads may be present in the same satellite or in different satellites, and for different satellites, the payloads may be in the same constellation or in different constellations. In general, the method 400 may be implemented using architecture such as architecture 300 as shown and described herein in reference to FIG. 3. The method 400 may facilitate a process to engage the first and second payloads in a zero-trust exchange.

At 402, the first satellite payload provides a request for a service to the distributed ledger network. The service may be computation time, data storage, or sensor data acquisition, by way of non-limiting examples. The request may be published to a ledger of the distributed ledger network and propagated to ledgers throughout the DLT network. The request may include a ‘blueprint’: a set of instructions defining how the service may be fulfilled. The blueprint may include a policy template (e.g., a lock).

In general, service-providing satellite payloads, such as the second satellite payload, may be regularly monitoring the distributed ledger for requests, checking for new activity. Upon seeing a service request, the second satellite payload may decide that it wishes to fulfill the request. Before proceeding, the second satellite payload may check the distributed ledger to determine if the first satellite payload is in bad standing. The bad standing status is designed to flag exploitative parties and encourage participation in the consensus (otherwise, payloads have no incentive to dedicate processing abilities to verifying transactions). The second satellite payload may decide to only proceeds if it determines that this is not the case. The second satellite payload then formulates a response and publishes it to the distributed ledger, e.g., in a partly encrypted form. This allows every satellite payload monitoring the distributed ledger to observe if the response fits the request presented by the first satellite payload without revealing potentially sensitive data in the second satellite payload's response. The first satellite payload may check whether the second satellite payload is in bad standing, e.g., by checking its or another copy of the distributed ledger in the distributed ledger network, and may not proceed with obtaining the second satellite's service response if so.

At 404, the first satellite payload obtains a service response from the second satellite payload and an indication of compliance with a policy concerning the service. The indication of compliance may be a key, which may be encrypted in such a way as to protect the integrity of the service's contents while remaining transparent enough to determine if the key conforms to the lock of 402. The first satellite payload may obtain the service response from a ledger of the distributed ledger network.

At 406, the first satellite payload determines, based on the indication of compliance, whether the service response conforms to the policy concerning the service, e.g., the blueprint, or policy template. For example, the first satellite payload may determine whether the key fits the lock.

Next, the first satellite payload acts on the service response based on the results of the determination of 406. The actions may take any of a variety of forms, as described presently in reference to 408, 410, 412, 414, 416, and 418. For example, the first satellite payload now has an opportunity to accept (e.g., one or more of 408, 410) or reject (e.g., one or more of 412, 414, 416, 418) the second satellite payload's response.

Along the accept pathway of method 400, at 408, if the first satellite payload is satisfied with the response, it proceeds to process the response, by way of non-limiting examples, by consuming or processing the service response data. Next, a transaction record is logged in a ledger of the distributed ledger system at 410. The transaction record may include the request and/or the response. Thus, along the accept pathway, the exchange proceeds as per the request and the blueprint does not need to be validated by other satellite payloads on the distributed ledger network, thereby not computationally taxing the network. Otherwise, the first satellite payload may contest the integrity of the second satellite payload's service response along the reject pathway.

Along the reject pathway of method 400, at 412, the first satellite payload requests validation of the integrity of the second satellite payload's service response over the distributed ledger, e.g., by converting it to a smart contract and publishing the smart contract to a ledger of the distributed ledger network. At this point, every payload on the distributed ledger network has the opportunity to certify the integrity of the second satellite payload's response to assess if it matches the requested blueprint.

At 414, the first satellite payload assesses the consensus among the reviewing satellite payloads in the distributed ledger network as to whether the service response from the second satellite payload conforms to the policy concerning the service. If the consensus is that the service response conforms to the policy, i.e., the consensus is of no non-conformance, then control passes to 416. Otherwise, if the consensus is that the service response does not conform to the policy, i.e., the consensus is of non-conformance, then control passes to 418.

At 416, because the consensus indicates that the service response conforms to the policy, a demerit against the first satellite payload is logged in a ledger of the distributed ledger network.

At 418, because the consensus indicates that the service response does not conform to the policy, a demerit against the second satellite payload is logged in a ledger of the distributed ledger network.

Thus, the first or second satellite payload for which the consensus sides against is given a demerit, e.g., strike towards the bad standing status, which is documented by the validators and posted across the distributed ledger.

More generally, strikes towards bad standing can also be given due to a lack of participation in the consensus, which may be monitored by the distributed service. According to some embodiments, validation that requires computational resources of participants is only requested when there is a dispute. When there is no dispute, requests and/or responses may be posted to the distributed ledger without validation and later pruned.

Many variations and alternative embodiments may be used. According to some embodiments, a minimum number of satellite payloads may be present before the system is operational, in order for the consensus operation to be meaningful. According to some embodiments, measures may be taken to reduce or minimize resource consumption by the system. Such measures may include, for example, either or both of: limiting validation to disputed transaction (e.g., as described above in reference to method 400), and/or stipulating a number of satellite payloads needed for consensus. Some embodiments may take measure against denial of service attacks. Such measures may include, for example, either or both of rate limiting and/or use of a strike/demerit system.

Various embodiments may enjoy a number of quantitative advantages over existing systems currently available to secure inter-agent interactions. First, embodiments may be resource efficient compared to other integral interaction services such as homomorphic encryption, which requires extensive power requirements not available on most space vehicles. Second, the fully distributed nature of some embodiments reduces the net weight and cost that any given payload incurs to participate because each does not need to be vertically integrated. Third, embodiments may expand the lifespan of any satellite given their modularity. Should a service (e.g., a sensor) no longer perform as intended as supplied by one provider payload, a payload requestor could request the same sensor service from a different provider, without experiencing extensive downtime.

Various embodiments may enjoy a number of qualitative advantages over existing systems currently available to secure inter-agent interactions. For example, some embodiments may allow for impromptu interactions between payloads without any prior configuration beyond installing a client on the participant system. As another example, some embodiments can rapidly identify bad actors that are not complying with service request policies and block their further engagement. Additionally, according to some embodiments, should a single payload be compromised, other payloads can be unimpeded given the fully distributed nature. In general, integrity-preserved provenance is a feature of permanent ledgers such as blockchains, where 51% of the nodes would need to be compromised in order to disrupt inter-agent consensus. Some embodiments allow for the possibility of new mission concepts of operation (CONOPS) via the proliferation of a distributed resilient network. This approach fosters more efficient mission design by eliminating the need for vertical integration in space systems: a system can delegate non-essential or infrequently-utilized services to other members of the network. Conversely, this also can spur development of small businesses to fill particular niches by adopting this burden. Yet further, some embodiments provide a platform that is mutually appealing to a wide variety of stakeholders, which introduces paths for cooperation that would otherwise be impossible—for example, an asset of a first country contracting an asset of an uncooperative or even adversarial second country to complete a data downlink.

Thus, systems and methods that can achieve a revolutionary advancement for space systems because they can incentivize the space sector to develop systems meant to scale and build on other's capabilities are presented. The fully distributed, provenance-preserving and consensus-driven nature of some embodiments may facilitate a truly zero-trust mechanism for engagement with the benefits of a software-defined network, which has not been achieved previously for space systems. Some embodiments may advance space system capabilities far beyond their expected use cases given they provide versatility and agility to system services. These are qualities of missions that have been elusive thus far, thereby limiting the ability for the space sector to truly scale. Some embodiments may also allow for more resilient constellations, as they may help provide quick-turn recovery should a service fail.

Certain examples can be performed using a computer program or set of programs. The computer programs can exist in a variety of forms both active and inactive. For example, the computer programs can exist as software program(s) comprised of program instructions in source code, object code, executable code or other formats; firmware program(s), or hardware description language (HDL) files. Any of the above can be embodied on a transitory or non-transitory computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented using computer readable program instructions that are executed by a processor.

These computer readable program instructions may be provided to a processor of a general-purpose computer, special purpose computer, or other programmable data processing apparatus, to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

In embodiments, the computer readable program instructions may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the C programming language or similar programming languages. The computer readable program instructions may execute entirely on a user's computer, partly on the user's computer, as a stand-alone software package, partly on the user's computer and partly on a remote computer or entirely on the remote computer or server.

As used herein, the terms “A or B” and “A and/or B” are intended to encompass A, B, or {A and B}. Further, the terms “A, B, or C” and “A, B, and/or C” are intended to encompass single items, pairs of items, or all items, that is, all of: A, B, C, {A and B}, {A and C}, {B and C}, and {A and B and C}. The term “or” as used herein means “and/or.”

As used herein, language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform] ing [a function] . . . ”, it is intended that such elements are to be interpreted under 35 U.S.C. § 112(f). However, for any claims containing elements designated in any other manner, it is intended that such elements are not to be interpreted under 35 U.S.C. § 112(f).

While the invention has been described with reference to the exemplary examples thereof, those skilled in the art will be able to make various modifications to the described examples without departing from the true spirit and scope. The terms and descriptions used herein are set forth by way of illustration only and are not meant as limitations. In particular, although the method has been described by examples, the steps of the method can be performed in a different order than illustrated or simultaneously. Those skilled in the art will recognize that these and other variations are possible within the spirit and scope as defined in the following claims and their equivalents.

1. A non-transitory computer readable medium comprising instructions that, when executed by an electronic processor, configures the electronic processor to perform a method of communicating between a first satellite payload in an electronic distributed ledger network and a second satellite payload in the electronic distributed ledger network, by performing actions comprising:
providing, by the first satellite payload and to the distributed ledger network, a request for a service;
obtaining, by the first satellite payload, a service response from the second satellite payload and an indication of compliance with a policy concerning the service;
determining, by the first satellite payload, and based on the indication of compliance, whether the service response conforms to the policy concerning the service; and
acting on the service response, by the first satellite payload, based on the determining.

2. The non-transitory computer readable medium of claim 1,
wherein the determining comprises determining that the service response conforms to the policy concerning the service, and
wherein the acting on the service comprises processing the service response by the first satellite payload.

3. The non-transitory computer readable medium of claim 1,
wherein the determining comprises determining that the service response does not conform to the policy concerning the service, and
wherein the acting on the service comprises sending, by the first satellite payload and to at least one node in the electronic distributed ledger network, a request to validate non-conformance of the service response to the policy concerning the service.

4. The non-transitory computer readable medium of claim 3, wherein the actions further comprise:
receiving, by the first satellite payload and from at least one node in the electronic distributed ledger network, a consensus indication of non-conformance of the service response to the policy concerning the service, and
refusing entry of the service response to the first satellite payload.

5. The non-transitory computer readable medium of claim 1, wherein the electronic distributed ledger network comprises one of a blockchain network or a directed acyclic graph network.

6. The non-transitory computer readable medium of claim 1,
wherein the receiving comprises retrieving the indication of compliance with the policy concerning the service from the electronic distributed ledger network.

7. The non-transitory computer readable medium of claim 1,
wherein the first satellite payload and the second satellite payload are hosted payloads present on a same satellite, and
wherein the sending is performed over an electronic bus.

8. The non-transitory computer readable medium of claim 1,
wherein the first satellite payload is present on a first satellite and the second satellite payload is present on a second satellite different from the first satellite, and
wherein the sending is performed over a wireless communication channel.

9. The non-transitory computer readable medium of claim 1, wherein the service comprises at least one of: computation time, data storage, or sensor data acquisition.

10. The non-transitory computer readable medium of claim 1, wherein the actions further comprise:
obtaining, by the first satellite payload and from the electronic distributed ledger network, an indication of past compliance by the second satellite payload.

11. The non-transitory computer readable medium of claim 1, wherein the actions further comprise:
advertising in a data and services marketplace, by the first satellite payload, a service that it is capable of providing and that is available for request.

12. A method of communicating between a first satellite payload in an electronic distributed ledger network and a second satellite payload in the electronic distributed ledger network, the method comprising:
providing, by the first satellite payload and to the distributed ledger network, a request for a service;
obtaining, by the first satellite payload, a service response from the second satellite payload and an indication of compliance with a policy concerning the service;
determining, by the first satellite payload, and based on the indication of compliance, whether the service response conforms to the policy concerning the service; and
acting on the service response, by the first satellite payload, based on the determining.

13. The method of claim 12,
wherein the determining comprises determining that the service response conforms to the policy concerning the service, and
wherein the acting on the service comprises processing the service response by the first satellite payload.

14. The method of claim 12,
wherein the determining comprises determining that the service response does not conform to the policy concerning the service, and
wherein the acting on the service comprises sending, by the first satellite payload and to at least one node in the electronic distributed ledger network, a request to validate non-conformance of the service response to the policy concerning the service.

15. The method of claim 14, further comprising:
receiving, by the first satellite payload and from at least one node in the electronic distributed ledger network, a consensus indication of non-conformance of the service response to the policy concerning the service, and
refusing entry of the service response to the first satellite payload.

16. The method of claim 12, wherein the electronic distributed ledger network comprises one of a blockchain network or a directed acyclic graph network.

17. The method of claim 12,
wherein the receiving comprises retrieving the indication of compliance with the policy concerning the service from the electronic distributed ledger network.

18. The method of claim 12,
wherein the first satellite payload and the second satellite payload are hosted payloads present on a same satellite, and
wherein the sending is performed over an electronic bus.

19. The method of claim 12,
wherein the first satellite payload is present on a first satellite and the second satellite payload is present on a second satellite different from the first satellite, and
wherein the sending is performed over a wireless communication channel.

20. The method of claim 12, wherein the service comprises at least one of:
computation time, data storage, or sensor data acquisition.

21. The method of claim 12, further comprising:
obtaining, by the first satellite payload and from the electronic distributed ledger network, an indication of past compliance by the second satellite payload.

22. The method of claim 12, further comprising:
advertising in a data and services marketplace, by the first satellite payload, a service that it is capable of providing and that is available for request.
